(19) United States
(12) Patent Application Publication
(10) Pub. No.: US 2004/0187336 A1
(43) Pub. Date: Sep. 30, 2004

(54) Structure of a tape rule housing

(76) Inventor: Shih-Lin Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/400,681

(22) Filed: Mar. 28, 2003

(51) Int. Cl. G01B 3/10

(52) U.S. Cl. 33/761

(57) ABSTRACT

Disclosed is an improved structure of a tape rule housing composed of an upper housing and a lower housing. A snap catch is formed on the upper housing to be snapped into a corresponding retaining groove formed at the lower housing such that two housing can be coupled together. Besides, each housing is provided with two corresponding internally threaded hollow posts which are engaged by tightening screws inserted from tapped holes opened on the top surface of the upper housing thereby further firmly combining the upper and the lower housings together suing less hollow posts and tightening screws than the conventional tape rule housing so as to curtail fabrication cost and facilitate assembly work.

### BACKGROUND OF THE INVENTION

1. Field of the Invention

The present invention relates to an improved structure of a tape rule housing, and more particularly, to an ingeniously designed tape rule housing which is easy to assemble and cut down the die making cost.

2. Description of the Prior Art

FIG. 1 is an exploded view illustrating the structure of a conventional tape rule housing composed of an upper housing 11 and a lower housing 12. Two internally threaded hollow posts 111 and 121 are respectively provided at the inner bottom portion of the upper housing 11 and the inner top portion of the lower housing 12. The hollow post 111 is piercing through the upper housing 11 up to form a tapped hole on its surface. Before coupling the upper and the lower housings 11 and 12 together, the hollow posts 111 and 121 must be mated with each other so as to engage the two housings 11 and 12 with a tightening screw 2 in the tapped hole.

In order to combine the upper and the lower housings 11, 12 with screw 2 described above, the two hollow posts 111 and 121 must be integrally fabricated in one piece by ejection respectively with the two housings 11 and 12. As result, the fabrication cost is increased by preparing a rather complicated die. If too many upper hollow posts 111 which penetrate the upper housing 11 are exaggerately used, the available spacing involved between the two housings 11, 12 will be narrowed, and outer looking of the upper housing 11 will be spoiled. Besides, the more the hollow posts 111 and 112 are used, the more the screws 2 are required, as a result, the overall fabrication cost will rise. Therefore, for saving the fabrication cost of the tape rule housing, the most urgent matter is to manage to reduce number of the hollow posts 111, 112.

In view of the foregoing situation, the present inventor herein conducted intensive research for many years and came to propose the present invention.

### SUMMARY OF THE INVENTION

The main object of the present invention is to provide an improved structure of the tape rule housing which is simply constructed without using too many hollow posts so as to curtail the fabrication cost.

To achieve the aforesaid object, the tape rule housing is composed of an upper housing and a lower housing, wherein the upper housing is provided with an internally threaded hollow post piercing through the top surface at each side to form a tapped hole thereon, while the lower house is also provided with a corresponding hollow post at each side to mate the former one. A snap catch is formed on the upper housing near its fringe to be snapped into a corresponding retaining groove provided at the lower housing such that the upper and the lower housings are coupled together. Furthermore, a tightening screw is inserted into each tapped hole opened on the top surface of the upper housing to engage the two hollow posts thereby firmly combining the two housings.

### BRIEF DESCRIPTION OF THE DRAWINGS

For fuller understanding of the nature and objects of the invention, reference should be made to the following detailed description taken in conjunction with the accompanying drawings in which:

FIG. 1 is an exploded view showing the component parts of a conventional tape rule housing, and also illustrating how to assemble them;

FIG. 2 is an exploded view showing the component parts of a tape rule housing according to the present invention, and also illustrating how to assemble them;

FIG. 3 is an assembled perspective view of the present invention;

FIG. 4A is a side cross sectional view for illustrating how to couple together the upper and the lower housings according to the present invention; and

FIG. 4B is a side cross sectional view showing the two housings are coupled together.

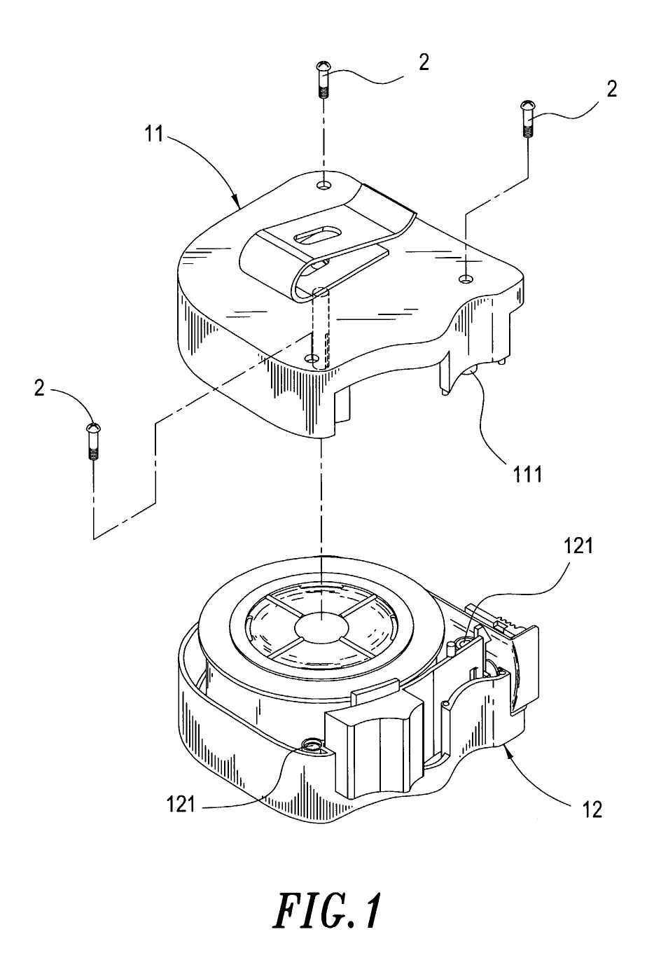

### DETAILED DESCRIPTION OF THE PREFERRED EMBODIMENT

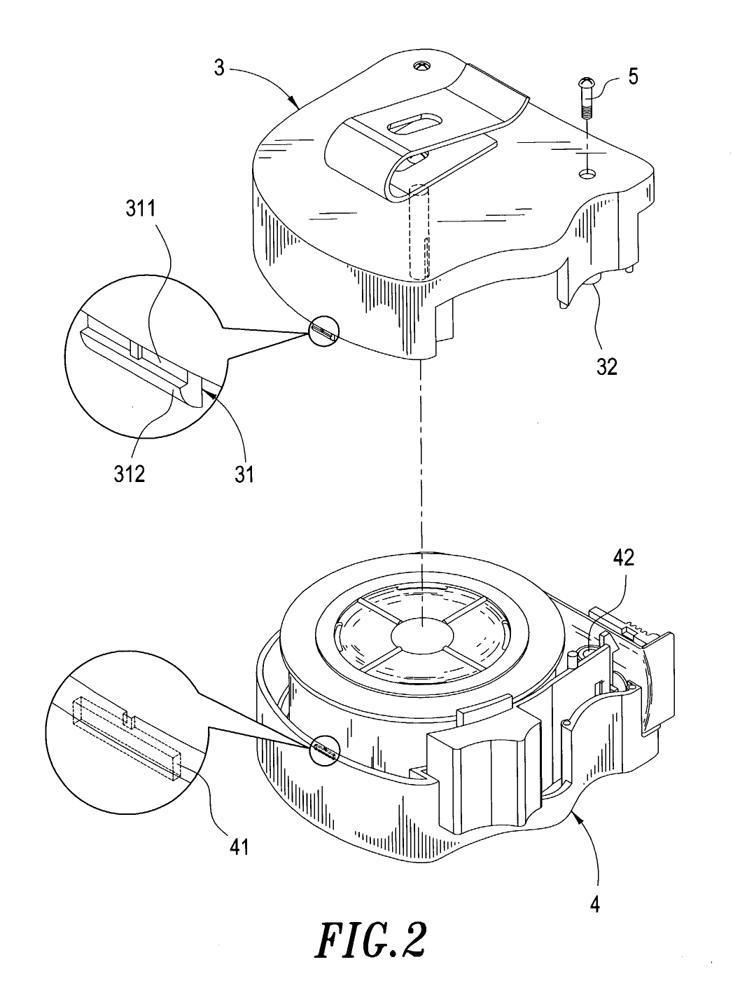

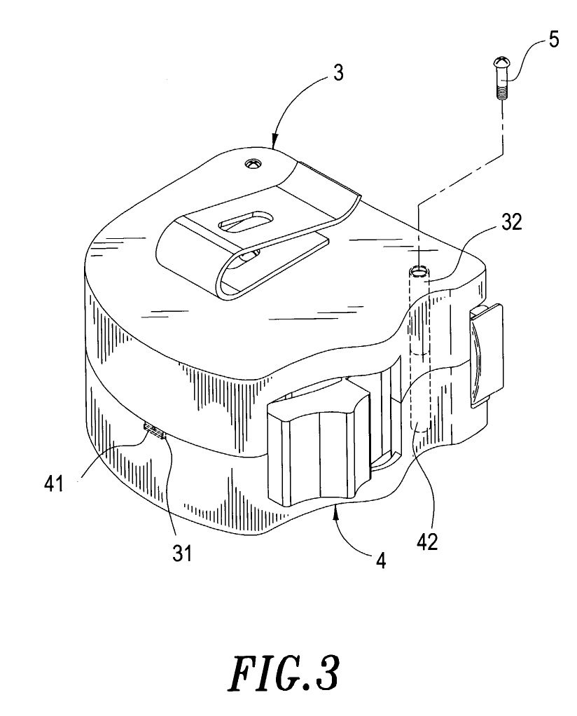

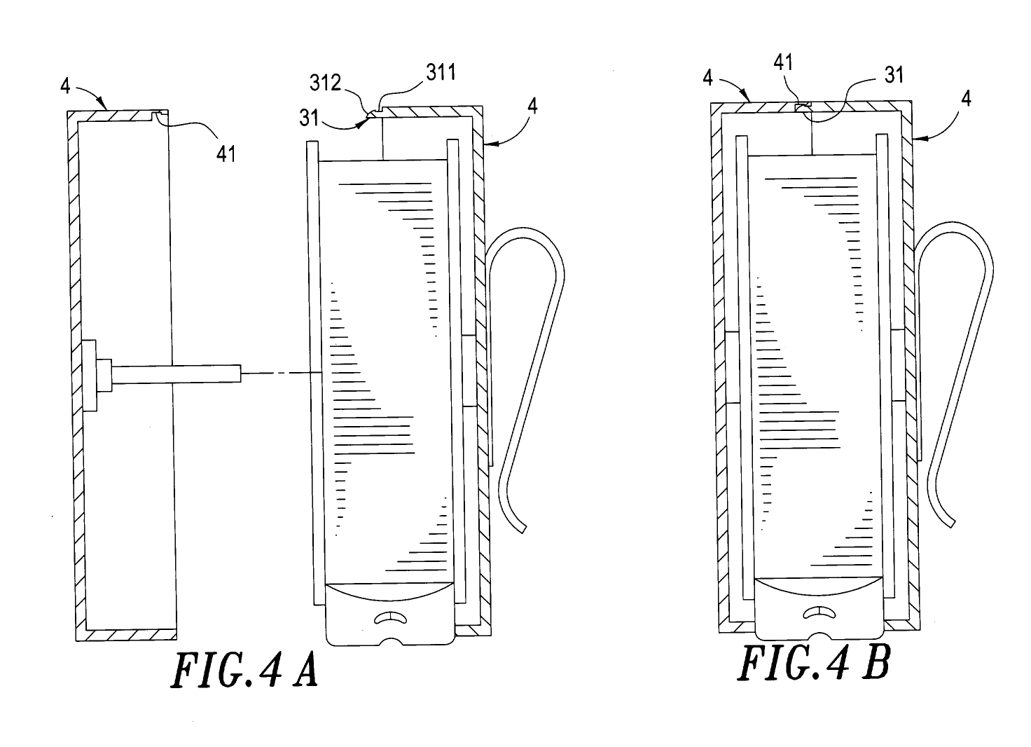

Referring to FIG. 2 through FIG. 4B, the tape rule hosing of the present invention comprises:

An upper housing 3, the housing 3 has a snap catch 31 formed near its fringe, the snap catch 31 is further composed of a spring clip plate 311 forming as its upper lip and a stop block 312 as its lower lip. An internally threaded hollow post 32 is provided downwardly on each side of the upper housing 3 and piercing through the top surface thereof to form a tapped hole.

A lower housing 4 provided with a retaining groove 41 on its upper fringe at a position corresponding to the snap catch 31 of the upper housing 3. The lower housing 4 are also provided with an internally threaded and upwardly erected hollow post 42 on each side respectively at the position corresponding to the hollow post 32.

For assembling the tape rule housing, the snap catch 31 is snapped down to push the stop block 312 into the retaining groove 41 together with the spring clip plate 311 which goes down the fringe of the lower housing 4 and is clogged there at such that the two housings 3, 4 are firmly coupled together by the snap catch 31. The two housings 3, 4 are further tightly combined together by inserting a tightening screw 5 into each tapped hole opened on the top surface of the upper housing 3 to engage the two mated hollow posts 32, 42 with the tightening screw 5.

Incidentally, the position for the snap catch 31 and its retaining groove 41 is not limited to the fringe portion of the two housings 3, 4, any convenient place is available for installation as long as the reliable snap engagement is possible.

It merges from the above description that the improved structure of a tape rule housing has some noteworthy features which are superior to the conventional ones, namely:

1. The structure of the housing is simplified by reduced use of hollow posts and associated screws that results in curtailing fabrication cost.

2. Reduced number of tapped holes on the housing makes the outer appearance of the tape rule clean and neat.

Those who are skilled in the art will readily perceive how to modify the invention. Therefore, the appended claims are to be construed to cover all equivalent structures which fall within the true scope and spirit of the invention.

1. Improved structure of a tape rule housing comprising:
an upper housing provided with an internally threaded hollow post piercing through the top surface at each side to form a tapped hole thereon;
a lower house provided with a corresponding hollow post at each side to receive mate the one said internally threaded hollow post of formed on said upper housing; wherein the characteristic of the structure is that, being characterized by:
a snap catch is formed internally on a fringe portion of said upper housing to be snapped into a corresponding retaining groove formed internally on a fringe portion of provided to said lower housing for interlocking such that said upper and said lower housings are coupled together, said snap catch and retaining groove being fully enclosed and hidden by said fringe portions when said upper and lower housings are coupled together, and furthermore a tightening screw is inserted into each tapped hole opened on the top surface of said upper housing to engage said two corresponding upper and lower hollow posts thereby theirby firmly combining said two housings.

2. The improved structure of a tape rule housing of claim 1, wherein said snap catch further includes a spring clip plate extending from said fringe portion of said upper housing forming as its upper lip and terminating at a transversely protruding stop block as its lower lip, said snap catch is snapped down to push said stop block engaging into said retaining groove formed on said lower housing in snap fit manner and to clog there.

3. The improved structure of a tape rule housing of claim 1, wherein said snap catch is formed to extend downward and inward from near the fringe portion of said upper housing.

4. The improved structure of a tape rule housing of claim 1, wherein said retaining groove is formed to extend in recessed manner in near the fringe portion of said lower housing.
